(19) United States
(12) Patent Application Publication
(10) Pub. No.: US 2017/0046353 A1
(43) Pub. Date: Feb. 16, 2017

(54) DATABASE MANAGEMENT SYSTEM AND DATABASE MANAGEMENT METHOD

(71) Applicant: HITACHI, LTD., Tokyo (JP)

(72) Inventors: Mika TAKATA, Tokyo (JP); Norifumi NISHIKAWA, Tokyo (JP); Yasushi MIYATA, Tokyo (JP); Nobuaki KOHINATA, Tokyo (JP)

(21) Appl. No.: 15/305,481

(22) PCT Filed: Jul. 29, 2014
(86) PCT No.: PCT/JP2014/069928

§ 371 Date: Oct. 20, 2016

(51) Int. Cl. G06F 17/30

(52) U.S. Cl. CPC G06F 17/30085; G06F 17/30117; G06F 17/30132

(57) ABSTRACT

A database management system (DBMS) is configured to delete, from a database storing information about time points associated with records, a record indicating a lapse of a predetermined time period since a time point indicated by associated information. The DBMS receives a remaining condition which indicates a time period during which a record is kept in the database regardless of the predetermined time period, and controls to keep a record in the database even after a lapse of the predetermined time period, based on the remaining condition.

### TECHNICAL FIELD

The present invention generally relates to a technique for managing a database.

### BACKGROUND ART

There has been known a technique for placing a frequently accessed file or a new file in a FC (Fibre Channel) disc and placing an infrequently accessed file or an old file in a SATA (Serial ATA) disc (PTL 1).

### CITATION LIST

### Patent Literature

### [PTL 1]

### Japanese Patent Application Publication No. 2004-295357

### SUMMARY OF INVENTION

### Technical Problem

In analysis of time series data, time series data that satisfy a search condition designated by a user (e.g., an analyzer) are searched for. One long time period or a plurality of discrete short time periods could be designated as the search condition.

Time series data are data that continuously increase moment by moment. In order to store time series data at least in a low-speed storage device (such as an archive), a plurality of time series data obtained every certain period of time could be taken as one file, allowing the time series data to be stored on a file basis.

Because time series data continuously increase moment by moment, storing new time series data in a high-speed storage device and at the same time deleting old time series data from the high-speed storage device could be performed frequently within a short period of time.

Therefore, while the complying time series data may be present in a high-speed storage device and therefore could be accessed fast in a search performed at a certain time point, in the same search performed after a certain period of time the complying series data may no longer be present in the high-speed storage device but in a low-speed storage device and therefore may be accessed slowly.

Simply applying the technique described in PTL 1 does not make it easy to solve the foregoing problems. This is because the fact that an old file does not remain in a high-speed storage device remains the same, and because the type of time series data is actually accessed in a search is unknown (for example, a large amount of continuous time series data may be accessed or significantly discrete time series data may be accessed).

This type of problem is not limited to searching and therefore could occur when accessing time series data satisfying a designated condition. This type of problem may occur also in a case where access is made to data other than time series data.

### Solution to Problem

A database management system (DBMS) is configured to delete, from a database that stores information about time points associated with records, a record indicating a lapse of a predetermined time period since the time point indicated by the associated information. The DBMS is also configured to receive a remaining condition which indicates a time period during which a record is kept in the database regardless of the predetermined time period, as well as to control to keep the record in the database even after a lapse of the predetermined time period, based on the remaining condition.

### Advantageous Effects of Invention

The present invention contributes to improving high-speed accessibility to data.

### BRIEF DESCRIPTION OF DRAWINGS

FIG. 1 shows an example of a hardware configuration of a computer system according to an example.

FIG. 2 shows an example of a function configuration of the computer system.

FIG. 3 shows an example of the relationship between a sensor data retention period and a sensor data placement location.

FIG. 4 shows an example of a CSV file.

FIG. 5 shows a configuration example of a DB.

FIG. 6 shows a configuration example of a placement management table.

FIG. 7 shows a flowchart of a process example of an import processing unit.

FIG. 8 shows a flowchart of a process example of a load function unit.

FIG. 9 shows a flowchart of a process example of a SQL parser.

FIG. 10 shows a flowchart of a process example of a DB engine.

FIG. 11 shows a flowchart of a process example of a data control unit.

FIG. 12 shows a flowchart of a process example of an external data access unit.

FIG. 13 shows an example of a sensor data monitoring GUI.

FIG. 14 shows an example of a remaining condition designation GUI provided by a reception unit.

FIG. 15 shows a configuration example of a remaining condition management table.

FIG. 16 shows a flowchart of another process example of the data control unit.

### DESCRIPTION OF EMBODIMENTS

An example is described hereinafter. The following often describes information managed in the form of “xxx management tables” and the like; however, such information may be managed in the form of data structures other than tables. Therefore, in order to describe that the expression of such information is not dependent on the forms of data structures, “xxx management tables” can be referred to as “xxx management information.” Also, such terms as “ID” and“name” are used as the identification information of each element; however, other types of identification information may be employed. Further, a program uses a memory and a communication port (a communication I/F) to perform a certain process by being executed by a processor; thus, “processor” may be the subject of a sentence that describes a process performed through the execution of a program. Part or whole of a program may be realized by dedicated hardware. Various programs may be installed on each computer by means of a program distribution server or a computer-readable storage medium.

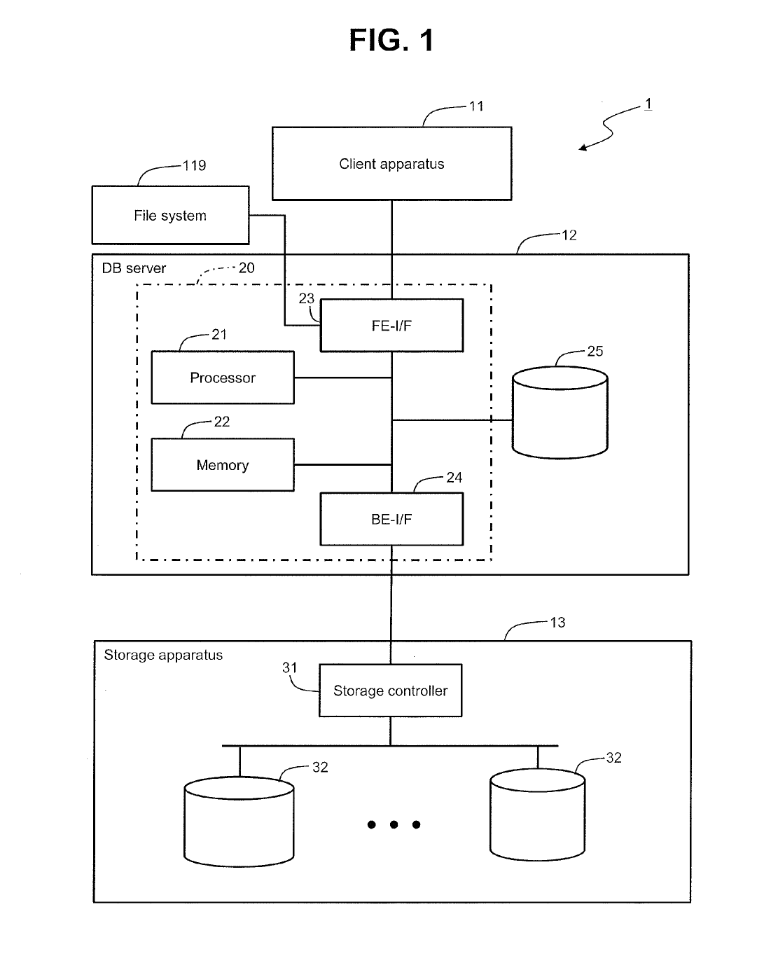

FIG. 1 shows an example of a hardware configuration of a computer system according to the example.

A computer system 1 has a client apparatus 11, a DB (database) server 12, a storage apparatus 13, and a file system 119. The client apparatus 11 and the DB server 12 may be coupled by a first communication network (such as a LAN (Local Area Network) or the Internet). The DB server 12 and the file system 119, too, may be coupled by the first communication network or the Internet. The DB server 12 and the storage apparatus 13 may be coupled by a second communication network (such as a SAN (Storage Area Network)) that is faster than the first communication network. The DB server 12 and the storage apparatus 13 may communicate with each other using the same protocol as a communication protocol (such as a PCIe) for communication performed by the internal components of the DB server 12 and the storage apparatus 13. At least one of the client apparatus 11, the DB server 12, the storage apparatus 13, and the file system 119 can exist in plurality.

The storage apparatus 13 has a plurality of (or one) storage devices 32 and a storage controller 31 that controls I/O (inputting/outputting) of data with respect to the plurality of storage devices 32. Typically the storage devices 32 are each a non-volatile storage device and may be, for example, a HDD (Hard Disk Drive) or an SSD (Solid State Drive). The storage controller 31 provides a logical storage area (logical volume) to the DB server 12 by controlling the plurality of storage devices 32. The storage controller 31 may configure a RAID (Redundant Arrays of Inexpensive (or Independent) Disks) group by controlling the plurality of storage devices 32.

The DB server 12 is an example of a computer (e.g., one physical computer or a set of physical computers), and has a memory 22, a storage device 25, an FE-I/F 23, a BE-I/F 24, and a processor 21 coupled to these components. The processor 21 is configured by one or more processors (e.g., microprocessors) and realizes one or a plurality of functions by reading a computer program from the memory 22 and executing the computer program. The memory 22 is configured by one or more memories and stores a computer program and data. The memory is a volatile or non-volatile memory and at least one from among, for example, a DRAM (Dynamic Random Access Memory), a FeRAM (Ferroelectric RAM), and a MRAM (Magnetoresistive RAM). The storage device 25 is configured by one or more storage devices (such as non-volatile storage devices) and may be, for example, an HDD or an SSD. The FE-I/F 23 is an interface device coupled to a front-end apparatus and controls transmission/reception of data between the DB server 12 and the client apparatus 11. The BE-I/F 24 is an interface device coupled to a back-end apparatus and controls transmission/reception of data between the DB server 12 and the storage apparatus 13. The processor 21, memory 22, FE-I/F 23 and BE-I/F 24 can collectively be referred to as “server controller.”

The client apparatus 11 may transmit a query (e.g., a search query) to the DB server 12 and receive the result of processing the query from the DB server 12. The client apparatus 11 is an example of a query transmission source.

The file system 119 is a file server (storage) independent of the DB server 12 but may be a file system provided in the DB server 12 (e.g., file system control for controlling a file system space and I/O of a file with respect to the file system space). The file system 119 stores one or more files therein.

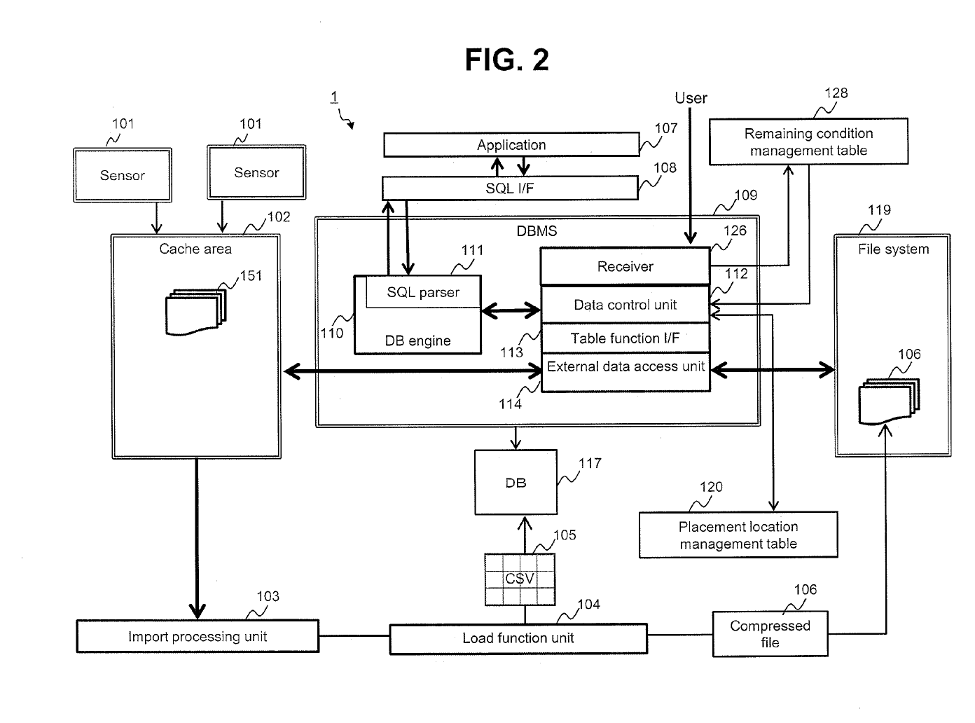

FIG. 2 shows an example of a function configuration of the computer system 1.

An overview of the computer system 1 is described first with reference to FIG. 2.

In the computer system 1, the DB server 12 temporarily saves time series data output from a sensor 101 in a cache area 102, and stores the time series data in at least either a DB 117 or the file system 119 on a time series data group basis. In the present example, the DB server 12 saves the time series data groups of the cache area 102 in both the DB 117 and the file system 119. Record groups corresponding to the time series data groups are added to the DB 117. Files having the time series data groups are stored in the file system 119. The time series data groups are each a set of two or more time series data, and these two or more time series data are accumulated periodically. Therefore, not all of the time series data groups have the same number of time series data. The DB server 12 registers a time point interval, a placement location and the like of each time series data group into a placement management table 120.

The DB server 12 deletes, from the DB 117, a record indicating a lapse of a predetermined time period (two years, for example) since the corresponding record time point. The term “record time point” means a time point indicated by the information associated with a record, such as a time point at which the record is stored in the DB 117 or a time point registered in the record. All of the data elements of time series data (at least a time point and a measurement value) corresponding to the record are recorded in this record. In addition, the term “predetermined time period” means a time period that is defined in advance, such as a default time period.

In a case where data satisfying a query condition (a condition designated by a query) do not exist in the DB 117, the DB server 12 acquires data satisfying the query condition from a table based on target files which contain data satisfying the query condition, the table being stored in the file system 119, and then returns the acquired data to the query transmission source (such as an application 107). The term “table based on target files” may mean a temporary table containing the time series data groups of the target files or the DB 117 that is updated based on the temporary table (a table inside the DB 117).

In searching for time series data, a user acquires data of various portions. The access performance of the file system 119 is lower than that of a database such as the DB 117 (i.e., the response time of the file system 119 is longer). Therefore, it is desirable that the data to be accessed (the data satisfying the query condition) be present in the DB 117 as much as possible. As described above, a record is deleted from the DB 117 after a lapse of the predetermined time period since the record time point corresponding to this record.

The DB server 12 receives designation of a remaining condition corresponding to a record. The remaining condition may be defined by one or more of a plurality of attributes that contain at least time points, the plurality of attributes concerning time series data, and values of these one or more attributes. The attributes other than time points can be the attributes desired by the user. The remaining condition may include at least a remaining time period. The term “remaining time period” means a time period during which a record is kept in the DB 117 regardless of the abovementioned predetermined time period (e.g., the default time period). The remaining time period may be longer or shorter than the predetermined time period. The DB server 12 receives the remaining condition through, for example, a user interface such as a GUI (Graphical User Interface). The computer system 1 registers the received remaining condition in a remaining condition management table 128. In a case where a record indicating a lapse of the predetermined time period since the corresponding record time point satisfies the remaining condition, the DB server 12 keeps this record in the DB 117. For example, even after a lapse of the predetermined time period since the record time point, the DB server 12 keeps the record with which this record time point is associated, in the DB 117. As a result, the record that includes the data to be accessed (e.g., the data satisfying the condition designated by the query) becomes more likely to exist in the DB 117, thereby improving high-speed accessibility to the time series data.

The DB server 12 can also manage access frequency of a record in units of predetermined data (e.g., in units of time series data groups or record units), and keep, in the DB 117, a frequently accessed record (e.g., the access frequency exceeding a predetermined threshold), even after a lapse of the predetermined time period since the corresponding record time point. As a result, a record including frequently accessed data becomes more likely to exist in the DB 117, thereby improving high-speed accessibility to the time series data.

The present example is described hereinafter in detail with reference to FIG. 2.

The computer system 1 has the cache area 102, an import processing unit 103, a load function unit 104, the DB 117, the file system 119, a DBMS 109, a SQL I/F 108, the application program (“application,” hereinafter) 107, the placement management table 120, the remaining condition management table 128, a SQL parser 111, a DB engine 110, a reception unit 126, a data control unit 112, a table function I/F 113, and an external data access unit 114.

In the present example, the DB server 12 has the cache area 102, the import processing unit 103, the load function unit 104, the DBMS 109, the SQL I/F 108, the placement management table 120, the remaining condition management table 128, the SQL parser 111, the DB engine 110, the reception unit 126, the data control unit 112, the table function I/F 113, and the external data access unit 114. However, of these elements, at least one of the cache area 102, import processing unit 103, load function unit 104, SQL I/F 108, placement management table 120, remaining condition management table 128, table function I/F 113, and external data access unit 114 may exist in an apparatus other than the DB server 12. For instance, both the placement management table 120 and the remaining condition management table 128 are tables that can be referred to by the DBMS 109.

According to the illustrated example, the DBMS 109 has the SQL parser 111, the DB engine 110, the reception unit 126, the data control unit 112, the table function I/F 113, and the external data access unit 114. However, at least one of the reception unit 126, table function I/F 113, and external data access unit 114 may exist outside the DBMS 109.

Furthermore, the import processing unit 103 and the load function unit 104 may be integrated into one element or divided into more elements. For example, the import processing unit 103 and the load function unit 104 are each an example of a storage unit. The SQL parser 111, the DB engine 110, and the data control unit 112, too, may be integrated into one element or divided into more elements. For example, the SQL parser 111, the DB engine 110, and the data control unit 112 are each an example of a control unit. The control unit may further include the table function I/F 113 and the external data access unit 114.

In the present example, at least one of the import processing unit 103, load function unit 104, SQL I/F 108, application 107, SQL parser 111, DB engine 110, reception unit 126, data control unit 112, table function I/F 113, and external data access unit 114 may be a function that is realized by the processor executing a computer program.

Sensor data 151 that are transmitted from a plurality of (or one) sensors 101 are stored in the cache area 102. The sensor data 151 are the time series data described in the present example. The sensor data 151 include a plurality of values corresponding to the plurality of attributes (including time points). For an attribute corresponding to a time point, the value thereof is expressed by a predetermined unit such as year, month, date, time, minute or second (the value representing a time point). For an attribute corresponding to a sensor ID (identifier of a sensor), the value thereof is expressed by a numeral, an alphabet or the like (the value representing a sensor ID). For an attribute corresponding to a metric (effective power, reactive power, or the like), the value thereof is a value corresponding to the metric (measured effective power value, reactive power value, or the like). The sensors 101 are each an example of a time series data source and may be an apparatus for measuring various situations involving a power system. The sensors 101 may measure the effective power value, reactive power value, power phase, frequency and the like obtained at a certain time point (or time) at a certain spot of the power system. The sensor data 151 is transmitted moment by moment (in a continuous stream) from each of the sensors 101, and the transmitted sensor data are accumulated in the cache area 102. The cache area 102 may be configured on the memory 22 or the storage device 25 or provided in an apparatus other than the DB server 12.

The import processing unit 103 acquires a sensor data group from the cache area 102 and creates a file containing the acquired sensor data group. For example, the import processing unit 103 may acquire, from the cache area 102, a sensor data group as a set of five minutes' worth of sensor data, and create one file containing these data (containing the five minutes' worth of sensor data). The import processing unit 103 includes, as the file, a CSV file 105 functioning as a base for registering the sensor data in the DB 117 (an example of a first type of file) and compressed files 106 (an example of a second type of file) that include the sensor data to be registered in the file system 119. The compressed files 106 may each be a compressed file of the CSV file 105. Examples of a compression technique include gzip and bzip2. The import processing unit 103 delivers the CSV file 105 and the compressed files 106 to the load function unit 104. Note that, once the sensor data group is acquired, the import processing unit 103 may delete this sensor data group from the cache area 102. As a result, an area for accumulating new sensor data can be created in the cache area 102. The import processing unit 103 may also register “cache area” in the placement management table 120 directly or indirectly (e.g., through the data control unit 112) as a placement location for placing a sensor data group in the cache area 102. The placement management table 120 is described hereinafter in detail. In the following description, data contained in the CSV file 105 that correspond to a single sensor data is called “measurement entry.” The CSV file 105 includes a measurement entry group (a set of two or more measured entries) corresponding to a sensor data group.

The load function unit 104 registers, in the DB 117, a measurement record group that corresponds to the measurement entry group contained in the CSV file 105 delivered from the import processing unit 103. The term “measurement record” means a record that includes data contained in a measurement entry. The load function unit 104 also stores the compressed files 106 delivered from the import processing unit 103, in the file system 119. In the present example, both the CSV file 105 and the compressed files 106 are created with respect to the same sensor data group, in which the measurement record group corresponding to the CSV file 105 is registered in the DB 117 and the compressed files 106 are stored in the file system 119. However, the method of storage is not limited to this example. In a case where only the CSV file 105 corresponding to the sensor data group is created; the measurement record group corresponding to this CSV file 105 is added to the DB 117; and the measurement record group is deleted from the DB 117, the measurement record group to be deleted may be formed into a file, which may then be moved to the file system 119. In other words, the compressed files 106 may be stored in such a manner that the sensor data output from the cache area 102 exist in at least either the DB 117 or the file system 119. In the following description, storing a measurement record group corresponding to a certain sensor data group into the DB 117 is described in short as “storing a sensor data group in the DB 117,” and storing the compressed files 106 corresponding to certain sensor data groups into the file system 119 is described in short as “storing a sensor data group in the file system 119.” Examples of file management by the file system 119 include FAT32 and ext3.

In a case where a sensor data group is stored in the DB 117, the load function unit 104 may register, in the placement management table 120, “DB” as a placement location for placing the sensor data group. In a case where a sensor data group is stored in the file system 119, the load function unit 104 may register, in the placement management table 120, “file system” as a placement location for placing the sensor data group. In a case where the same sensor data group is stored in both the DB 117 and the file system 119, “DB” (i.e., the storage destination with better access performance) may be registered as a placement location for placing this sensor data group.

The SQL I/F 108 provides the application 107 with an I/F that uses SQL (Structured Query Language). For example, a search request of the application 107 may be converted into a SQL query (a query expressed in SQL) by the SQL I/F 108, which may then be transmitted to the DBMS 109. Such SQL query is also simply referred to as “query,” hereinafter.

The DBMS 109 manages the DB 117. The DBMS 109 may control the remaining condition management table 128, the placement management table 120, and at least one of the compressed files of the file system 119. The DBMS 109 has the DB engine 110, the data control unit 112, the table function I/F 113, and the external data access unit 114. The DB engine 110 may have the SQL parser 111.

The SQL parser 111 parses SQL and causes the DB engine 110 to execute the analyzed SQL query. In a case where a table function is included in the SQL query, the SQL parser 111 may cause the data control unit 112 to execute this table function.

The DB engine 110 executes the SQL query obtained as a result of parsing by the SQL parser 111. For example, the DB engine 110 searches for, adds, deletes and changes records in the DB 117.

In a case where the predetermined time period (two years, for example) has elapsed since the record time point corresponding to a measurement record, the data control unit 112 deletes this measurement record from the DB 117. This is because it is difficult to keep the measurement records of all the sensor data stored in the DB 117 when the sensor data keep increasing moment by moment. In so doing, for a measurement record satisfying the remaining condition, the data control unit 112 may not delete this measurement record even after a lapse of the predetermined time period since the record time point corresponding thereto. The data control unit 112 may not also delete frequently accessed (i.e., the number of accesses per unit time is equal to or greater than a predetermined threshold) measurement records even after a lapse of the predetermined time period. This is because keeping those frequently accessed measurement records in the DB 117 can improve the search speed.

The data control unit 112 creates and updates the placement management table 120. The data control unit 112 may search the placement management table 120 for a management record satisfying a search condition. A search condition is an example of the query condition (condition designated in a query). The data control unit 112 may add a management record to the placement management table 120, delete a management record satisfying the condition from the placement management table 120, and change the value designated in the management record satisfying the condition. The data control unit 112 may also add a new column to or delete an existing column from the placement management table 120. The data control unit 112 can receive a request for adding, deleting or changing a column from the user through the user interface, and add, delete or change a column in response to such request. Adding, deleting or changing a column is equivalent to adding, deleting or changing a measurement attribute managed by the DB 117 and the placement management table 120.

The data control unit 112 can also allow the DB 117 and the file system 119 to collaborate with each other. For example, in a case where the DB 117 does not have a measurement record satisfying a certain search condition (a search condition designated in a search query), the data control unit 112 acquires a compressed file containing data satisfying the search condition from the file system 119 through the external data access unit 114 based on, for example, the placement management table 120. The data control unit 112 then creates a temporary table in which is stored a record group corresponding to the sensor data group owned by the acquired compressed file. The data control unit 112 may store the record group of this temporary table in the DB 117. The DB engine 110 can search the DB 117 for a measurement record satisfying the search condition, and when the DB 117 does not have such measurement record, acquire data satisfying the search condition through the data control unit 112. In other words, the data control unit 112 can search the DB 117 and the file system 119 seamlessly. The data control unit 112 can find out, based on the placement management table 120, a placement location for data complying with the search condition (whether such placement location exists in any of the cache area 102, the DB 117 and the file system 119 or not). The data control unit 112 may include the cache area 102 as the scope of search in addition to the DB 117 and the file system 119.

The table function I/F 113 is an I/F through which the data control unit 112 uses the external data access unit 114. The data control unit 112 may call up an external function of the external data access unit 114 through the table function I/F 113 and access the file system 119 or the cache area 102.

The external data access unit 114 accesses the compressed files 106 stored in the file system 119 and the sensor data groups stored in the cache area 102.

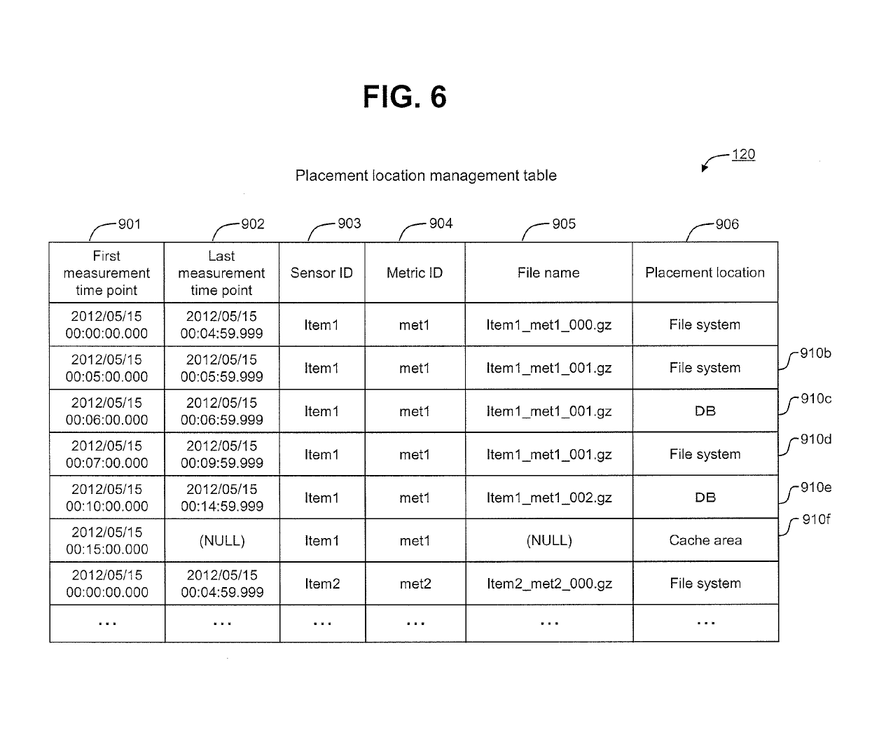

The placement management table 120 has a management record for each sensor data group. The management records indicate where the sensor data groups corresponding thereto are located, i.e., the DB 117, the file system 119, or the cache area 102. The placement management table 120 is described hereinafter in detail (see FIG. 6).

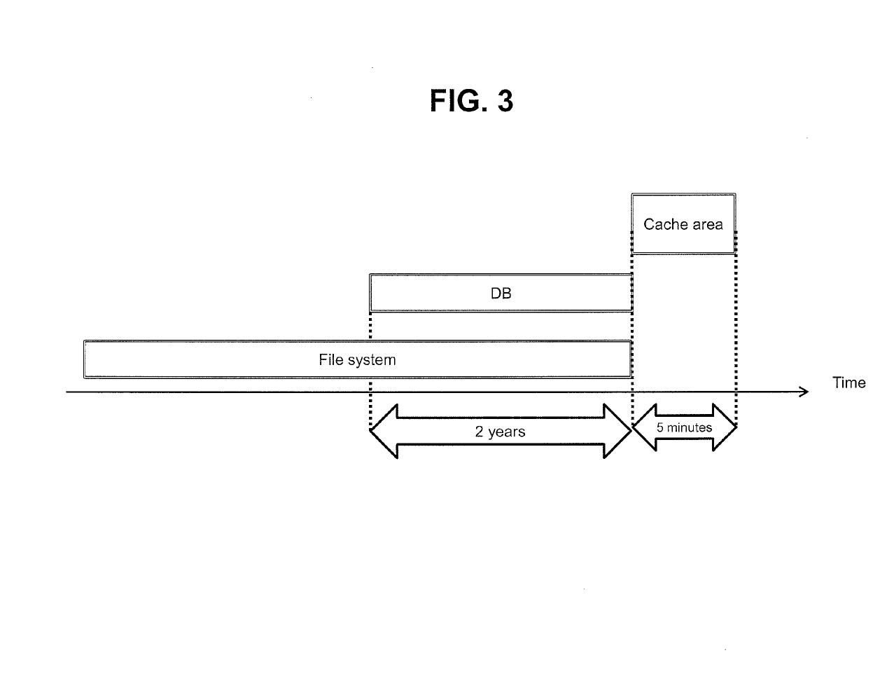

FIG. 3 shows an example of the relationship between a sensor data retention period and a sensor data placement location.

Sensor data transmitted from the sensors 101 are stored in the cache area 102. Every five minutes, the import processing unit 103 acquires a sensor data group accumulated in the cache area 102. In other words, sensor data can be retained in the cache area 102 for up to five minutes. A sensor data group, a set of five minutes' worth of sensor data, is stored in both the DB 117 and the file system 119.

After a lapse of two years since a sensor data group is stored in the DB 117, this sensor data group is deleted. However, of this sensor data group, the sensor data satisfying a predetermined condition (e.g., sensor data satisfying the remaining condition or frequently accessed sensor data) remain in the DB 117. Sensor data (measurement records) may be deleted on a sensor data group basis or on a sensor data basis.

Sensor data groups are stored in the file system 119 as the compressed files 106. Sensor data groups may be saved at all times in the file system 119, as shown in the diagram. In the present example, as shown in the diagram the sensor data groups stored in the cache area 102 (five minutes' worth of sensor data) are stored in both the DB 117 and the file system 119, but the sensor data groups may be stored in the DB 117 first, and then after a lapse of two years since the sensor data groups are stored, the sensor data of the sensor data groups other than the sensor data satisfying the predetermined condition may be moved from the DB 117 to the file system 119. As described above, the placement locations for the sensor data that are stored in both the DB 117 and the file system 119 (redundantly) are expressed as “DB.” This is because the DB 117 has better access performance than the file system 119 and is therefore considered a priority scope of search.

The foregoing predetermined time period (two years) for which sensor data are saved in the DB 117 is also referred to as “DB retention period,” hereinafter.

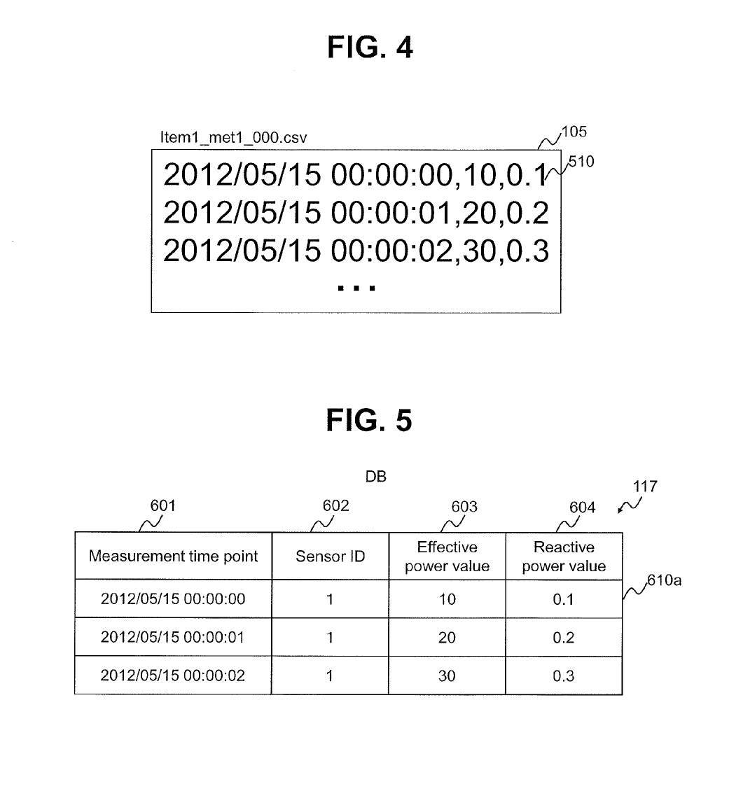

FIG. 4 shows an example of the CSV file 105.

The CSV file 105 has a measurement entry group (two or more measurement entries) corresponding to a sensor data group (five minutes' worth of sensor data). In the CSV file 105, one row may represent one measurement entry. Each of the values configuring one measurement entry may be separated by commas.

For example, in the CSV file 105 shown in FIG. 4, the first value of the measurement entry 510 in the first row represents a time point at which a measurement value is measured (“measurement time point,” hereinafter). The second value represents an effective power value measured at the measurement time point. The third value represents a reactive power value measured at the measurement time point.

The file name of the CSV file 105 may include an attribute related to the corresponding sensor data (“measurement attribute,” hereinafter). Examples of the measurement attribute may include a sensor ID and a metric ID. A sensor ID is a piece information for identifying the sensor 101 that measures sensor data. A metric ID is a piece of information for identifying the metric (the type of the measurement value) corresponding to the sensor data. The relationship between the metric ID and the measurement value may be configured beforehand. For example, metric ID “met1” may be configured beforehand as an identifier representing a metric corresponding to an effective power value and a reactive power value.

In CSV file name “Item1_met1_000.csv” shown in FIG. 4, “Item1” represents the sensor ID and “met1” represents the metric ID. The numeral “000” represents the file serial number.

FIG. 5 shows a configuration example of the DB 117.

Measurement record groups are saved in the DB 117 for two years. The measurement entries indicating a lapse of the retention period of two years are deleted sequentially from the DB 117. Components of a measurement record (i.e., components of sensor data) include a plurality of values corresponding to a plurality of measurement attributes related to sensor data, such as a measurement time point 601, a sensor ID 602, an effective power value 603, and a reactive power value 604.

The measurement time point 601 represents a time point at which the measurement values (an effective power value and a reactive power value) are measured. The measurement time point 601 may be a time point at which sensor data are stored in the cache area 102. The sensor ID 602 represents information for identifying the sensor 101 that outputs sensor data corresponding to a measurement record (that measures the measurement values inside the sensor data). The effective power value 603 represents an effective power value (kW) that is measured at a certain measurement time point by the sensor 101 corresponding to a certain sensor ID 602. The reactive power value 604 represents a reactive power value (kW) that is measured at a certain measurement time point by the sensor 101 corresponding to a certain sensor ID 602.

The DB 117 may be present in the storage apparatus 13 or in the memory 22 of the DB server 12 (in-memory).

FIG. 6 shows a configuration example of the placement management table 120.

The placement management table 120 has a management record for each sensor data group. Each of the management records has a first measurement time point 901, a last measurement time point 902, a sensor ID 903, a metric ID 904, a file name 905, and a placement location 906.

The first measurement time point 901 represents a time point corresponding to the first sensor data of the corresponding sensor data group. The last measurement time point 902 represents a measurement time point corresponding to the last sensor data of the corresponding sensor data group. Since a sensor data group is a set of two or more time series data, a group of sensor data from the first measurement time point 901 to the last measurement time point 902 is contained in a compressed file corresponding to this sensor data group (a compressed file shown by the file name 905).

The sensor ID 903 represents information for identifying the sensor 101 that outputs sensor data of the corresponding sensor data group. The metric ID 904 represents information for identifying the metric of the measurement value inside each of the sensor data in the corresponding sensor data group. The file name 905 represents a file name of the compressed file of the corresponding sensor data group.

The placement location 906 represents where the corresponding sensor data group is located. For example, in a case where the placement location 906 shows “file system,” it means that the relevant sensor data group is placed in the file system 119. In a case where the placement location 906 shows “DB,” it means that the relevant sensor data group is placed at least in the DB 117. In a case where the placement location 906 shows “cache area,” it means that the relevant sensor data group (sensor data obtained at the time point represented by the first measurement time point 901 and sensor data obtained after the time point) is placed in the cache area 102 and that this sensor data group is not yet acquired from the cache area 102 by the import processing unit 103. Based on the placement location 906, sensor data can be acquired not only from the DB 117 and the file system 119 but also from the cache area 102.

As shown in FIG. 3, in a case where sensor data groups are saved in the DB 117 for two years, the placement locations 906 of the management records corresponding to sensor data groups saved for two years or less since the last measurement time point 902 show “DB,” and the placement locations 906 of the management records corresponding to the sensor data groups indicating a lapse of two years since the last measurement time point 902 show “file system.” This is because the sensor data groups indicating a lapse of two years since the last measurement time point 902 are deleted from the DB 117 and saved only in the file system 119.

In a case where the access frequency of a part of a sensor data group corresponding to a compressed file is high, the data control unit 112 may divide the compressed file into a first compressed file (an example of a first file) corresponding to the partial sensor data group with high access frequency (one or more sensor data) and one or more second compressed files (an example of a second file) corresponding to the rest of the sensor data group (one or more sensor data), and create management records for the first compressed file and the one or more second compressed files respectively. For example, the compressed file corresponding to the sensor data group having time point interval “00:05:00.000 to 00:09:59.999” may be divided into three compressed files (see management records 910b to 910d corresponding to the respective three compressed files). Specifically, for example, of this sensor data group, in a case where the access frequency of the sensor data group having a time point interval “00:06:00.000 to 00:06:59.999” is high, the data control unit 112 divides one compressed file into a first compressed file corresponding to the sensor data group having a time point interval “00:06:00.000 to 00:06:59.999” and two second compressed files corresponding to the other sensor data groups (a compressed file corresponding to the sensor data group of “00:05:00.000 to 00:05:59.999” and a compressed file corresponding to the sensor data group of “00:07:00.000 to 00:09:59.999”). The data control unit 112 then eliminates the sensor data group corresponding to the first compressed file from the deletion target in the DB 117. As a result, possibility that the access target data might exist in the DB 117 increases, enabling more efficient use of the DB 117 than when all of the five minutes' worth of sensor data groups remain in the DB 117. In a case where the access frequency of a sensor data group of a certain time point interval contained in a certain compressed file in the file system 119 is high, the data control unit 112 may add a measurement record group corresponding to this sensor data group of this time point interval to the DB 117. In this case, in the placement management table 120 the data control unit 112 updates the placement location for the sensor data group (measurement record group) added to the DB 117, to “DB.”

Note that the access frequency that is managed based on a predetermined data unit (e.g., sensor data group unit, measurement record unit) may be managed in the placement management table 120 or in a management table or the like other than the placement management table 120 by the data control unit 112.

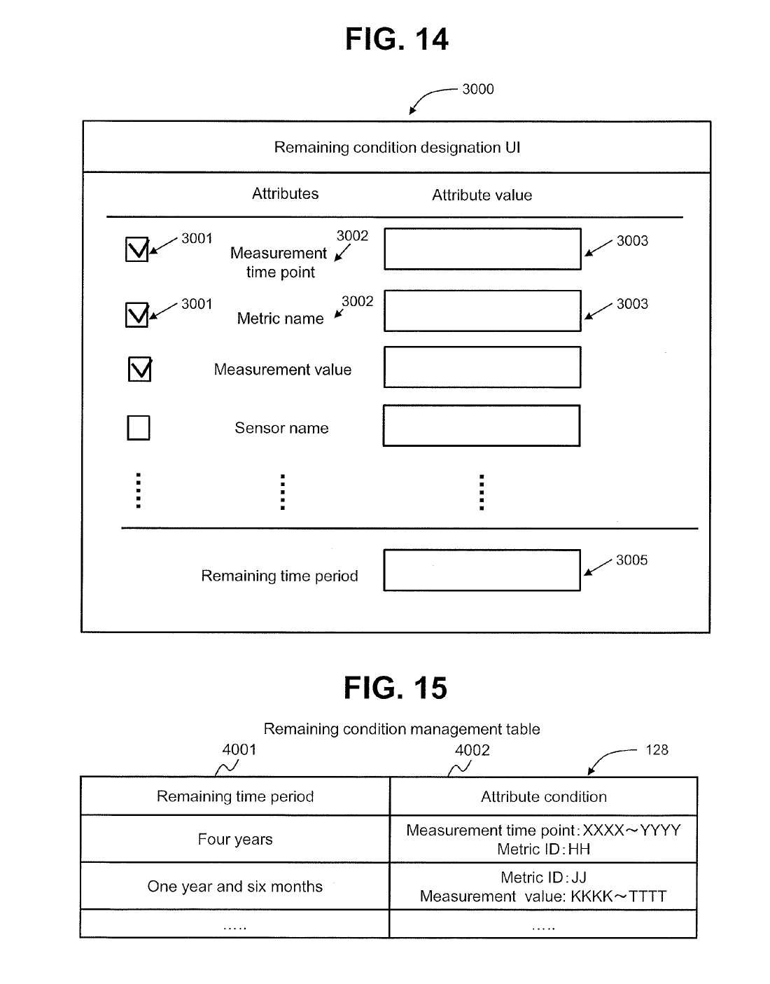

FIG. 14 shows an example of a remaining condition designation GUI provided by the reception unit 126.

A remaining condition designation GUI 3000 is an example of the user interface and provided by the reception unit 126 to a display console coupled to the DB server 12. The display console may be a display device (not shown) or an external apparatus with a display device (e.g., the client apparatus 11 having a display device or a management computer (not shown) having a display device). The user can input a remaining condition into the remaining condition designation GUI 3000. The remaining condition includes a remaining time period. The user described in the present example may be a user of the application 107 executed by the client apparatus 11 or the like or a user of the DBMS 109 (e.g., an administrator).

The remaining condition designation GUI 3000 has, for each of the plurality of measurement attributes concerning the sensor data, a selection tool (e.g., a checkbox) 3001 for specifying whether to select or not, an attribute name 3002, and an input tool 3003 for inputting a value of a measurement attribute. As shown in the diagram, the input tool may be a text input box or a box such as a pull-down menu. The user checks the checkbox 3001 corresponding to a desired measurement attribute (more specifically, selects a measurement attribute) and enters the value corresponding to the selected measurement attribute in the input tool 3003. The remaining condition designation GUI 3000 also has a remaining time period input tool 3005. The term“remaining time period” means a time period during which certain sensor data are kept in the DB 117 and is shown as a variable value, unlike the DB retention period shown as a fixed value. The user can enter, in the input tool 3005, a remaining time period of sensor data satisfying a desired remaining condition. Entering a remaining time period may not be necessary. In a case where a remaining time period is not entered, a default remaining time period (e.g., a total of the DB retention period (two years) and a predetermined time period) may be entered. The difference between the DB retention period and a remaining time period (e.g., plus one year, minus three months) may be entered as well. Specifically, the remaining time period may be defined by the difference with the DB retention period.

The information that is entered for each of the plurality of measurement attributes by using the GUI components 3001, 3003 and 3005, in other words, one or more attribute/value sets (a set of the selected measurement attribute and the value corresponding to this measurement attribute) and the remaining time period, configure the remaining condition. The remaining condition may be either one of the one or more attribute/value sets and the remaining time period (e.g., only the remaining time period).

FIG. 15 shows a configuration example of the remaining condition management table 128.

The remaining condition management table 128 has a remaining time period 4001 and an attribute condition 4002, for each remaining condition entered. The remaining time period 4001 and the attribute condition 4002 are information registered by the reception unit 126.

The remaining time period 4001 represents a remaining time period entered in the UI 300 shown in FIG. 14 (or the default remaining time period specified beforehand by the user). The attribute condition 4002 shows the one or more attribute/value sets entered in the UI shown in FIG. 14. Although the measurement attribute name 3002 shown in FIG. 14 displays metric name/sensor name, metric ID/sensor ID may be associated with metric name/sensor name and the attribute condition 4002 may contain metric ID/sensor ID in place of or in addition to metric name/sensor name.

As shown in FIG. 15, the user can enter a time period shorter than the DB retention period, as the remaining time period. This allows the records corresponding to the sensor data satisfying the remaining condition to be deleted from the DB 117 before the DB retention period is elapsed.

Because the remaining time period to be associated with the remaining condition can be specified as described above, the records remaining in the DB 117 can more finely be designated.

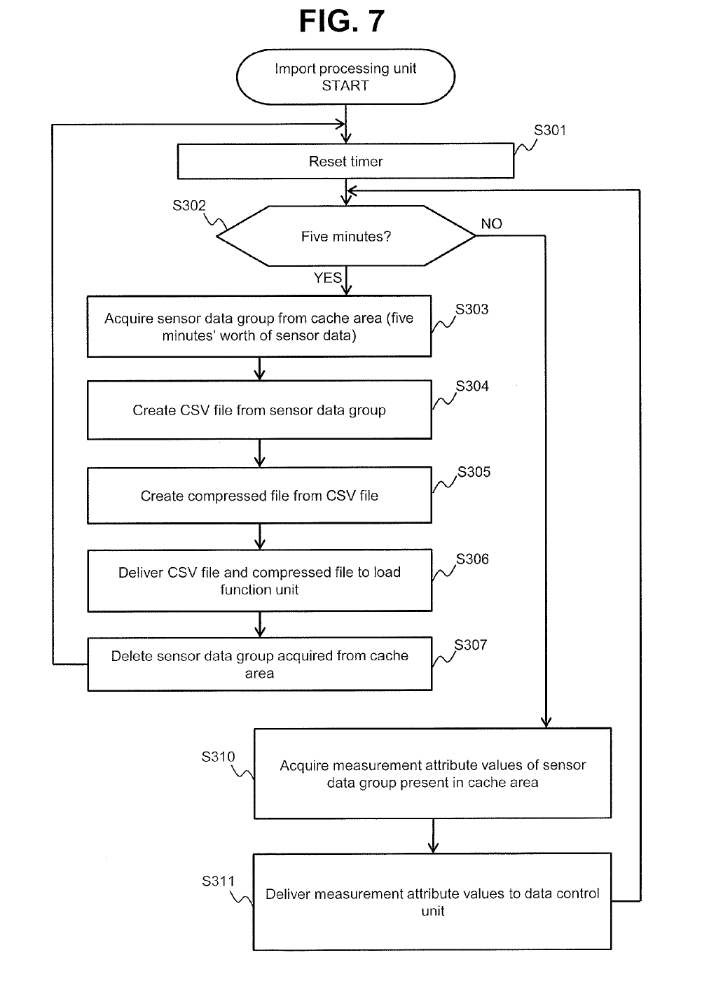

FIG. 7 shows a flowchart of a process example of the import processing unit 103.

The import processing unit 103 resets a timer (S301). The import processing unit 103 determines whether the time period elapsed since resetting the timer is equal to or longer than five minutes or not (S302).

In a case where the time period elapsed is shorter than five minutes (S302: NO), the import processing unit 103 acquires the measurement attribute values (values corresponding to the measurement attributes) related to the sensor data groups that are present in the cache area 102 at the moment (S310).

The import processing unit 103 delivers the acquired measurement attribute values of the sensor data to the data control unit 112 (S311). For example, the import processing unit 103 delivers time point interval “00:15:00.000 to present moment,” sensor ID “Item1,” and metric ID “met1” to the data control unit 112 as shown in a management record 910f of the placement management table 120 of FIG. 6, and the data control unit 112 registers time point interval “00:15:00.000 to (Null),” sensor ID “Item1,” metric ID “met1,” file name (Null), and placement location “cache area” in the management record 910f. In a case where the source of the measurement attribute values corresponding to the sensor data group is the import processing unit 103, the data control unit 112 can determine that the placement location for the sensor data group is the cache area 102. The import processing unit 103 may send “cache area” to the data control unit 112 as the placement location.

In a case where the time period elapsed is equal to or longer than five minutes (S302: YES), the import processing unit 103 acquires the sensor data group (five minutes' worth of sensor data) from the cache area 102 (S303). The import processing unit 103 then creates a CSV file representing the sensor data group (S304). The import processing unit 103 creates a compressed file (e.g., a gzip file) from the created CSV file (S305). The import processing unit 103 delivers the created CSV file and compressed file to the load function unit 104 (S306). The import processing unit 103 then deletes the sensor data group acquired in S303 from the cache area 102.

As a result of the foregoing process, the sensor data that are accumulated in the cache area 102 as time passes are sent to the load function unit 104 and deleted from the cache area 102 with a predetermined period on a sensor data group basis.

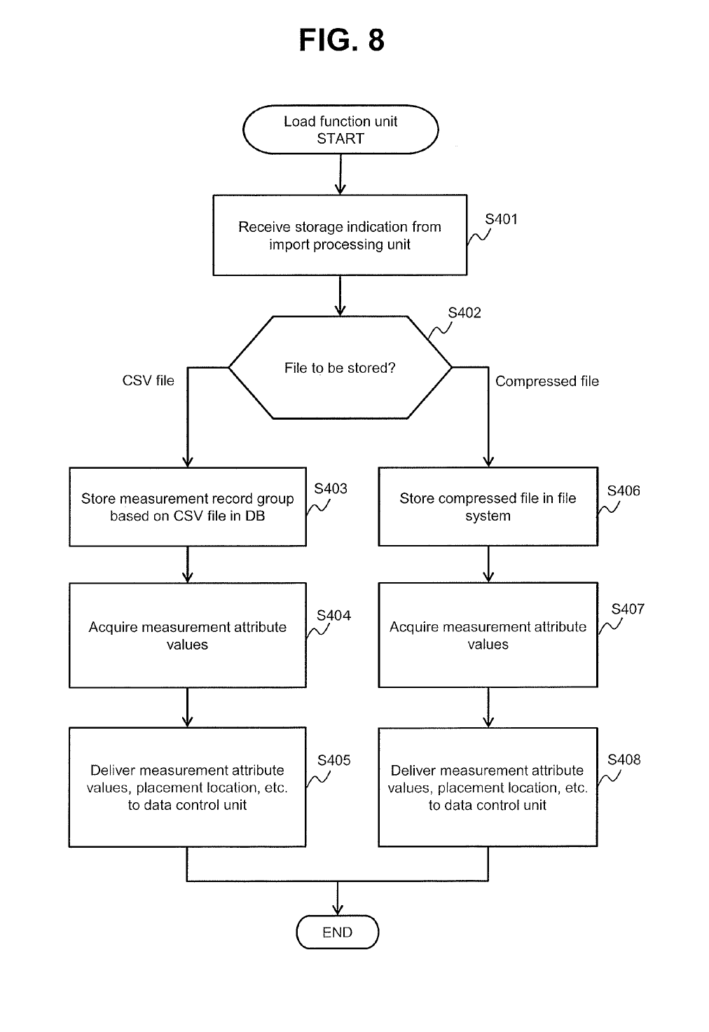

FIG. 8 shows a flowchart of a process example of the load function unit 104.

The load function unit 104 determines whether the file from the import processing unit 103 is a CSV file or a compressed file (S402).

In a case where the file is a CSV file (S402: CSV file), the load function unit 104 stores a measurement record group corresponding to the sensor data group in the DB 117, based on the CSV file (S403). The load function unit 104 acquires the measurement attribute values of the measurement record group (sensor data group) stored in the DB 117 (S404). The load function unit 104 delivers, to the data control unit 112, the acquired measurement attribute values, the placement location “DB,” and the file name of the corresponding compressed file to the data control unit 112 (S405). The data control unit 112 adds the management record corresponding to the sensor data group stored in the DB 117 to the placement management table 120 (e.g., a management record 910e shown in FIG. 6). Note that, in a case where the same file name as the file name of the compressed file is registered in the management table and the placement location corresponding thereto shows “file system,” the data control unit 112 updates this placement location to “DB.”

In a case where the file is a compressed file (S402: Compressed file), the load function unit 104 stores the compressed file in the file system 119 (S406). The load function unit 104 acquires the measurement attribute values of the sensor data group contained in the compressed file (S407). The load function unit 104 then delivers, to the data control unit 112, the acquired measurement attribute values, the placement location “file system,” and the file name of the stored compressed file to the data control unit 112 (S408). The data control unit 112 adds the management record of the sensor data group stored in the file system 119 to the placement management table 120. However, for example, in a case where the same file name as the file name of the compressed file is registered in the management table and the placement location corresponding thereto shows “DB,” the foregoing addition to the management table is skipped.

As a result of the foregoing process, the sensor data group is stored in the DB 117 and the file system 119. Note that S407 and S408, for example, may be omitted from the process shown in FIG. 8. This is because the management record that corresponds to the sensor data group from the cache area 102 and is added to the placement management table 120 overlaps with the measurement attribute values as a result of S404 and S405.

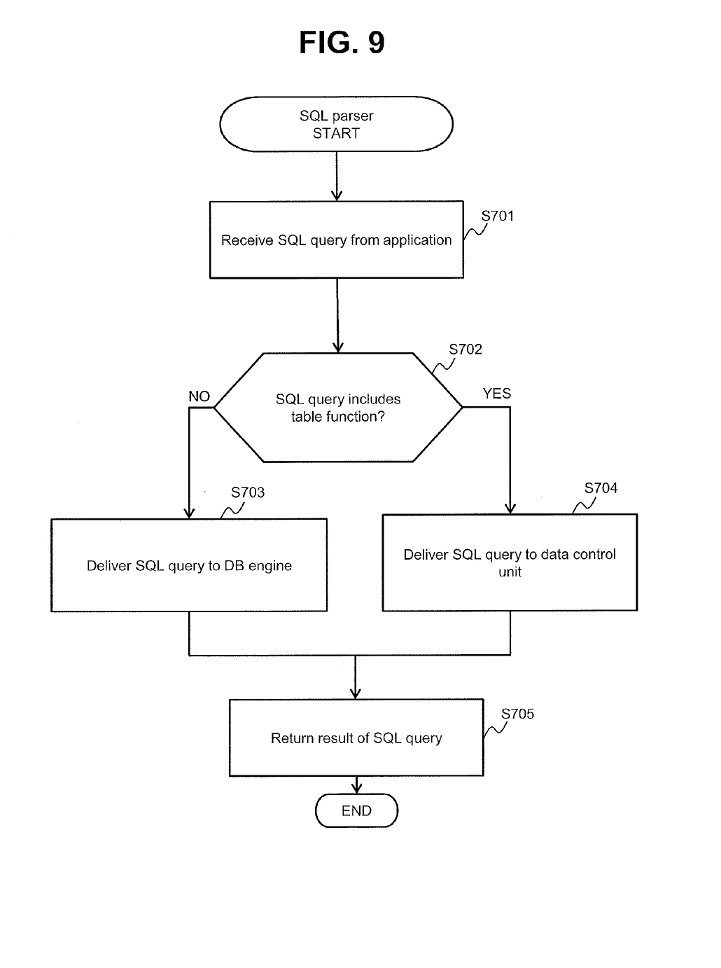

FIG. 9 shows a flowchart of a process example of the SQL parser 111.

The SQL parser 111 receives a SQL query from the application 107 through the SQL I/F 108 (S701) and determines whether or not this query includes a table function requiring external access (S702). In a case where the table function is not included (S701: NO), the SQL parser 111 delivers the SQL query to the DB engine 110 (S703). In a case where the table function is included (S701: YES), the SQL parser 111 delivers the SQL query to the data control unit 112 (S704). The SQL parser 111 receives the result of the execution of the SQL query from the DB engine 110 or the data control unit 112 and returns the result of the execution to the application 107 (S705).

As a result of the foregoing process, the SQL query that does not include the table function is processed by the DB engine 110, and the SQL query that includes the table function is processed by the data control unit 112.

In S702, in place of or in addition to determining whether the SQL query includes the table function or not, the SQL parser 111 may determine, based on the placement management table 120, whether the placement location for the data satisfying the query condition (the condition designated in the SQL query) is “DB” or not. In a case where the placement location is “DB,” S703 is performed, but when the placement location is “file system” or “cache area,” S704 is performed.

S703 may be performed without performing S702. In other words, the SQL query may always be delivered to the DB engine 110. In a case where an error is returned from the DB engine 110 (e.g., when the result of the execution of the SQL query indicates an error), S704 may be performed.

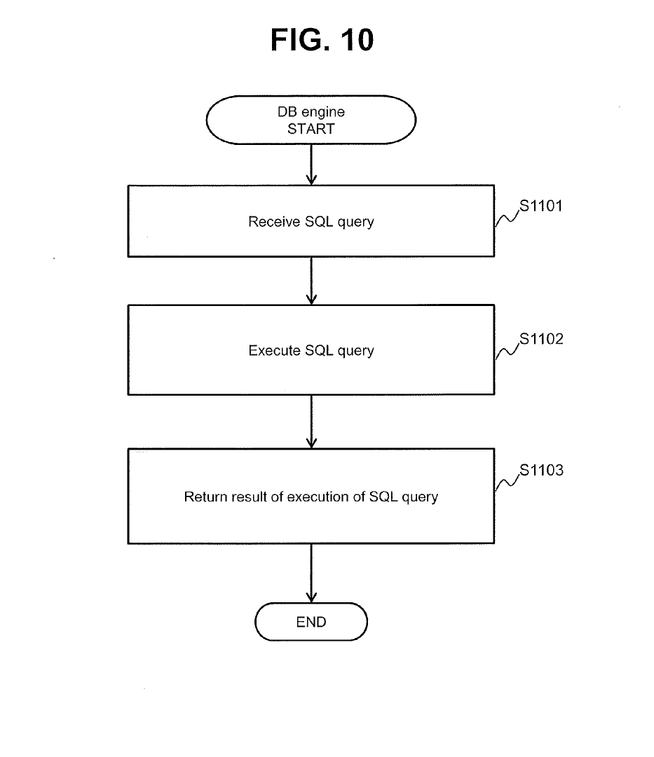

FIG. 10 shows a flowchart of a process example of the DB engine 110.

The DB engine 110 receives a SQL query from the SQL parser 111 or the data control unit 112 (S1101) and executes the received SQL query for the DB 117 (S1102). For example, in a case where the query is a search query, the DB engine 110 extracts, from the DB 117, data that satisfy the search condition designated in the query. The DB engine 110 returns the result of the execution of the SQL query (including the extracted data, for example) to the caller of the DB engine 110 (the SQL parser 111 or the data control unit 112, in the present example) (S1103).

As a result of the foregoing process, the DB engine 110 can return the result of the execution of the SQL query (the search result and the like) to the caller of the DB engine 110.

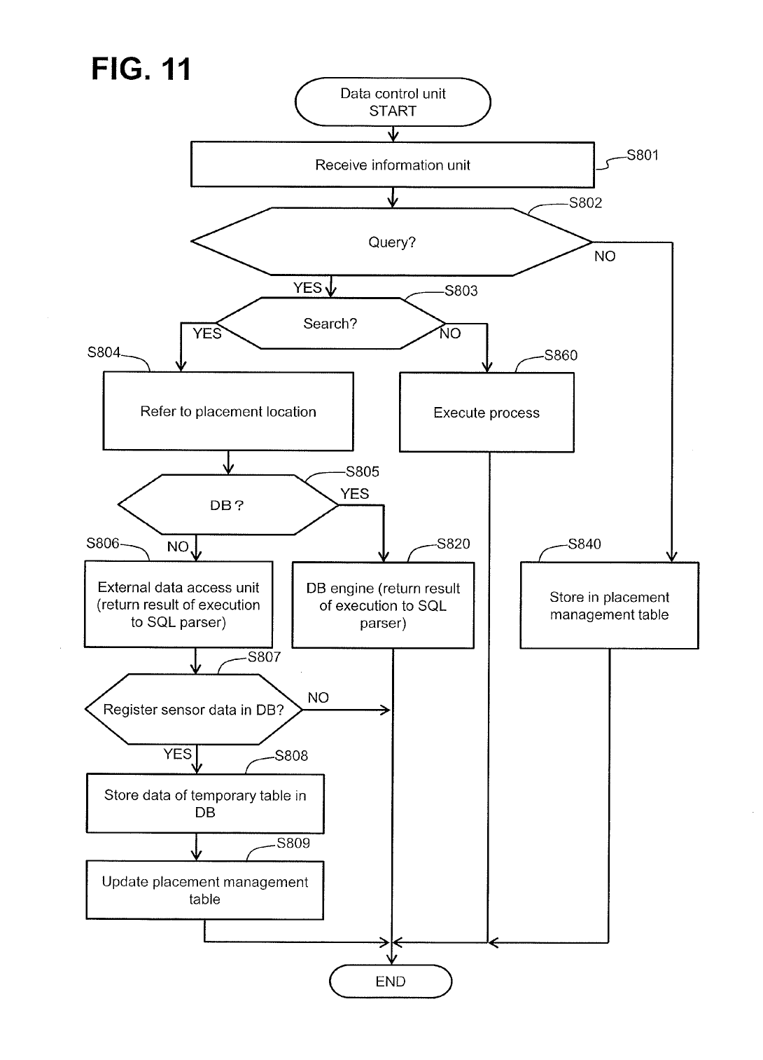

FIG. 11 shows a flowchart of a process example of the data control unit 112.

The data control unit 112 receives an information unit (S801). The information unit can be measurement attribute values from the import processing unit 103 or the load function unit 104 or a query from the SQL parser 111.

In a case where the information unit is not a query (in a case where the information unit is a measurement attribute value or the like) (S802: NO), the data control unit 112 stores the received measurement attribute or the like in a management record of the placement management table 120 (S860). In a case where, in the placement management table 120, there exists a management record overlapping with the received measurement attribute value or the like; the placement location for the received measurement attribute value or the like is “DB”; and the placement location 906 of the overlapping management record is “file system,” the data control unit 112 may update the placement location 906 from “file system” to “DB.”

As a result of the foregoing process, the data control unit 112 stores the measurement attribute values and the like sent from the import processing unit 103 or the load function unit 104 in the placement management table 120.

Next is described the case where the information unit is a query (S802: NO). The data control unit 112 determines whether the query is a search query or not (S803).

In a case where the query is a query other than a search query (e.g., in a case where the record is to be updated, deleted and the like) (S803: NO), the data control unit 112 executes a process based on the query (S860). For example, in a case where the query indicates that the record that includes the data satisfying the condition designated in the query is to be deleted from the DB 117, the data control unit 112 changes the placement location 906 for this record from “DB” to “file system” and deletes the record from the DB 117. Furthermore, for example, in a case where the query indicates that a new measurement attribute is to be added to the DB 117, the data control unit 112 adds a column for the new measurement attribute to the DB 117 and adds a column for the new measurement attribute to the placement management table 120 as well.

In a case where the query is a search query (S803: YES), the data control unit 112 specifies, in the placement management table 120, a management record corresponding to the time point interval including a time point designated as one of the search conditions, and refers to the placement location 906 corresponding to the management record (S804). Then, the data control unit 112 determines whether the placement location 906 is “DB” or not (S805).

In a case where the placement location 906 is “DB” (S805: YES), the data control unit 112 delivers the SQL query to the DB engine 110, receives the result of the execution from the DB engine, and returns this result of the execution to the SQL parser 111 (S820).

In a case where the placement location 906 is not show “DB” (S805: NO), the data control unit 112 performs S806. For example, in a case where the placement location 906 is “file system,” the data control unit 112 acquires the file name of the compressed file from the file name 905 of the management record that corresponds to the sensor data group containing sensor data satisfying the search condition, and delivers the acquired file name to the external data access unit 114. Furthermore, for example, in a case where the placement location 906 is “cache area,” the data control unit 112 delivers the search conditions to the external data access unit 114. The data control unit 112 then receives the result of the execution (including, for example, the delivered file name and the sensor data corresponding to the search condition) from the external data access unit 114 and returns this result of the execution to the SQL parser 111. The data control unit 112 determines whether the sensor data in the result of the execution (the sensor data obtained as the search result) need to be registered in the DB 117 or not (S807). For example, in a case where the file containing the sensor data is acquired from the file system 119 at a predetermined frequency or more, the data control unit 112 may determine that at least the sensor data in the sensor data group that satisfy the search condition, the sensor data group being represented by this file, need to be registered in the DB 117.

In a case where the result of the determination in S807 is positive (S807: YES), the data control unit 112 stores, in the DB 117, at least the sensor data satisfying the search condition of the temporary table (S808). The data control unit 112 then changes the placement location 906 from “file system” to “DB” for the sensor data registered in the DB 117 (S809).

As a result of the foregoing process, the data control unit 112 can use the external data access unit 114 and the DB 110 separately, depending on the data placement locations, and consequently the SQL parser 111 and the DB engine 110 do not need to be conscious about the data placement locations.

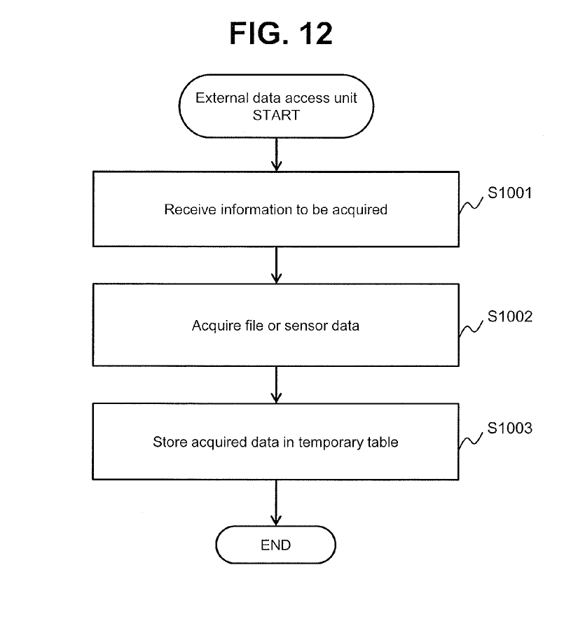

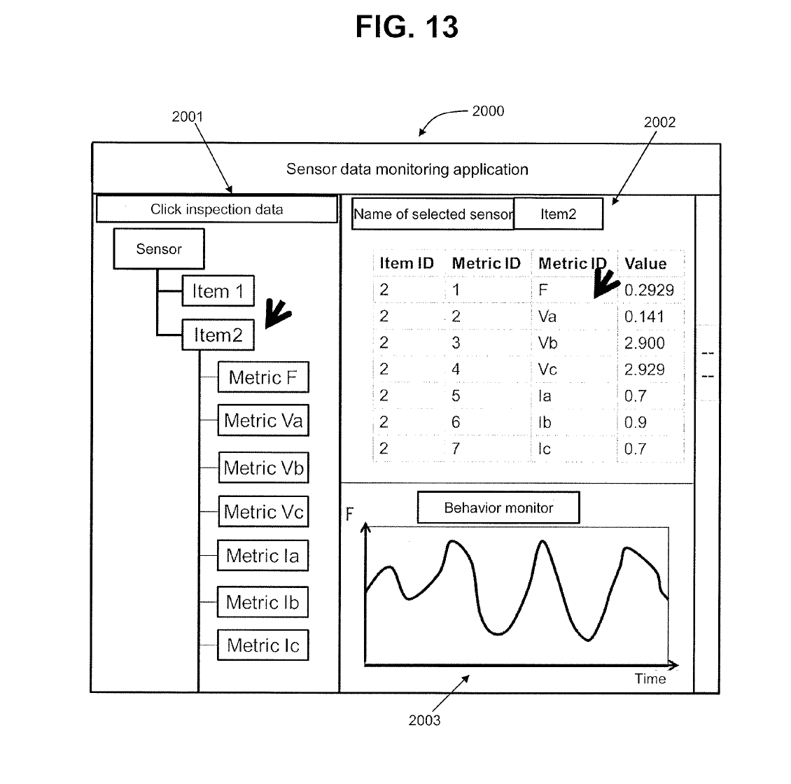

FIG. 12 shows a flowchart of a process example of the external data access unit 114.

The external data access unit 114 receives information to be acquired (S1001). The information to be acquired is the file name of a compressed file or a search condition for sensor data. The external data access unit 114 acquires a compressed file corresponding to a file name from the file system 119 or acquires sensor data satisfying a search condition from the cache area 102 (S1002). The external data access unit 114 stores the sensor data group of the acquired compressed file or the acquired sensor data in a temporary table (S1003). The temporary table may be created by the data control unit 112 or the like beforehand or by the external data access unit 114 in S1003. The external data access unit 114 can return the fact that the data are stored in the temporary table, to the caller of the external data access unit 114.

As a result of the foregoing process, the file or sensor data can be acquired from the file system 119 or cache area 102, and the sensor data in the file or the acquired sensor data can be stored in the temporary table. The sensor data in the temporary table are stored in the DB 117 in S808 shown in FIG. 11.

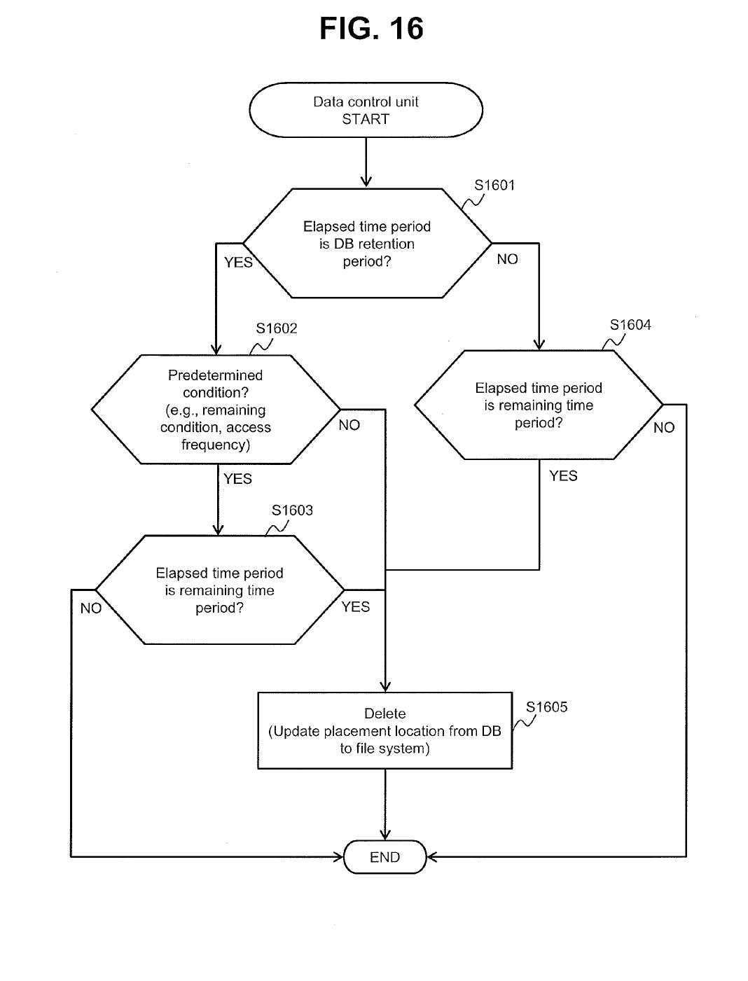

FIG. 16 shows a flowchart of another process example of the data control unit 112.

This process example shows controlling deletion of records from the DB 117, which is performed for, for example, each individual measurement record repeatedly (e.g., on a regular basis). The process shown in FIG. 16 is described hereinafter, taking one measurement record as an example.

The data control unit 112 determines whether the time period elapsed since the record time point corresponding to the measurement record reaches the DB retention period or not (S1601).

In a case where the result of the determination in S1601 is positive (S1601: YES), the data control unit 112 determines whether the measurement record satisfies a predetermined condition or not (S1602). The term “predetermined condition” here means a condition for keeping the measurement record in the DB 117 even if the elapsed time period has reached the DB retention period, and examples of the predetermined condition include a remaining condition, a condition that the access frequency is equal to or larger than a predetermined threshold, and the like.

In a case where the result of the determination in S1602 is negative (S1602: NO), the measurement record is deleted on the expiry of the DB retention period. In other words, the data control unit 112 deletes the measurement record from the DB 117 and changes the placement location 906 corresponding to this measurement record from “DB” to “file system” (S1605).

In a case where the result of the determination in S1602 is positive (S1602: YES), the data control unit 112 determines whether the time period elapsed since the record time point of the measurement record reaches a remaining time period or not (S1603). The remaining time period here means the remaining time period indicated by a remaining condition (e.g., the remaining time period corresponding to the attribute condition satisfied by the measurement record).

In a case where the result of the determination in S1603 is negative (S1603: NO), the data control unit 112 keeps the measurement record in the DB 117 (i.e., does not delete the measurement record from the DB 117).

In a case where the result of the determination in S1603 is positive (S1603: YES), the measurement record is deleted on the expiry of the remaining time period. In other words, S1605 is executed.

In a case where the result of the determination in S1601 is negative (S1601: NO), the data control unit 112 determines whether or not the measurement record satisfies any of remaining conditions and whether or not the elapsed time period reaches the remaining time period corresponding to this remaining condition (S1604). This is because a time period shorter than the DB retention period could be designated as the remaining time period.

In a case where the result of the determination in S1604 is positive (S1604: YES), the measurement record is deleted on the expiry of the remaining time period. In other words, S1605 is executed.

In a case where the result of the determination in S1604 is negative (S1604: NO), it means that the DB retention period (and a deletion time period) has not expired. Therefore, the data control unit 112 keeps the measurement record in the DB 117 (i.e., does not delete the measurement record from the DB 117).

The foregoing process controls whether to delete or keep a measurement record.

FIG. 14 shows an example of a sensor data monitoring GUI.

A sensor data monitoring GUI 2000 is a GUI that is displayed by a sensor data monitoring application and that monitors (e.g., analyzes) sensor data. The sensor data monitoring application is an example of the application 107 described above. The GUI 2000 has a first selection area 2001, a second selection area 2002, and a measurement value display area 2003.

A list of measurement attributes, for example, is displayed in the first selection area 2001. A sensor data group complying with the measurement attribute selected from the first selection area 2001 is displayed in the second selection area 2002. Measurement values based on the sensor data group selected from the second selection area 2002 are displayed in the measurement value display area 2003. For example, as shown in FIG. 14, when sensor ID “Item2” is selected from the first selection area 2001, the sensor data group corresponding to sensor ID “Item2” is displayed in the second selection area 2002. When sensor data corresponding to metric ID “1” is selected from the second selection area 2002, the measurement values corresponding to sensor ID “Item2” and metric ID “1” are displayed in the measurement value display area 2003 in chronological order (e.g., in the form of a line graph). In this operation, the sensor data monitoring application appropriately transmits a request such as a search request, and this request is input to the SQL parser 111 as a SQL query.

The foregoing example is merely illustrative of the present invention and is not intended to limit the scope of the present invention thereto. Those skilled in the art can implement the present invention in various ways without departing from the gist of the present invention.

For example, as to the time series data described herein, time series data other than sensor data can be employed. In place of the time series data, the present invention may be employed to various types of data.

Moreover, the remaining time period may be, for example, zero. Specifically, the remaining condition could be a remaining condition for a record that is not saved in the DB 117. In this case, the control unit (e.g., the data control unit 112) deletes the record (e.g., a record corresponding to an attribute condition indicating zero remaining time period) from the DB 117 or does not store the record (e.g., the record corresponding to the attribute condition indicating zero remaining time period) in the DB 117, based on the remaining condition. In case of the latter, for example, the control unit (e.g., the data control unit 112) does not store in the DB 117 the measurement record that includes the data of a measurement entry that corresponds to the attribute condition indicating zero remaining time period (e.g., does not create such a record).

In addition, for example, the remaining condition (e.g., the remaining time period) may include a time period during which data are kept in the cache area. Specifically, the reception unit 126 may receive, as the remaining conditions (e.g., the remaining time periods), the remaining condition for the cache area 102 in addition to the remaining condition for the DB 117, and register the remaining condition for the cache area 102 in the remaining condition management table 128, in addition to the remaining condition for the DB 117. The control unit (e.g., the data control unit 112) may store, in the DB 117, the data kept in the cache area 102 as a measurement record, and delete the data stored in the DB 117 from the cache area 102, based on the remaining condition for the cache area 102 (the remaining condition registered in the remaining condition management table 128). Specifically, according to this modification, in place of or in addition to creating a sensor data group every five minutes and deleting the sensor data groups from the cache area 102, sensor data can be stored in the DB 117 at time points other than every five minutes and delete the sensor data from the cache area 102, based on the remaining conditions. In a case where the control unit (e.g., the data control unit 112) receives a query (an example of an access request from the application 107) and the sensor data satisfying the query condition (an example of data corresponding to an access target record) are present in the cache area 102, the control unit may instruct to the application 107 to access the access target data (the sensor data satisfying the query condition) stored in the cache area 102 or acquire the sensor data satisfying the query condition from the cache area 102 and provide the acquired sensor data to the application 107. In case of the former, the control unit may, for example, provide the address of the position of the access target data to the application 107 and then the application 107 may acquire the access target data located at this address (i.e., the data inside the cache area 102) without going through (or by going through) the DBMS 109.

In addition, for example, the DBMS 109 may have storage units (e.g., the import processing unit 103 and the load function unit 104).

### REFERENCE SIGNS LIST

1 Computer system
12 DB server
109 DBMS
117 DB
119 File system
120 Placement management table
128 Remaining condition management table

1. A database management system for deleting, from a database storing information about time points associated with records, a record indicating a lapse of a predetermined time period since a time point indicated by associated information, the database management system comprising:
a reception unit configured to receive a remaining condition which indicates a time period during which a record is kept in the database regardless of the predetermined time period; and
a control unit configured to control to keep a record in the database even after a lapse of the predetermined time period, based on the remaining condition received by the reception unit.

2. The database management system according to claim 1, wherein the control unit is configured, in a case where the database does not have an access target record that is accessed by an executed application program, to specify a file corresponding to the access target record from a file system that stores a file containing the content of at least a record to be deleted from the records stored in the database, and then add the access target record to the database, based on the specified file.

3. The database management system according to claim 2, wherein
the reception unit is configured to receive a remaining condition of a record accessed by the application program, and
the control unit deletes a record added to the database, from the file system, based on a time period designated under the received remaining condition.

4. The database management system according to claim 2, wherein
the reception unit is configured to receive a remaining condition of a record that is not to be saved in the database, and
the control unit is configured to delete the record from the database or not to store the record in the database, based on the received remaining condition.

5. The database management system according to claim 3, wherein
the time period designated under the remaining condition includes a time period during which received data are saved in a cache area, and
the control unit is configured to save the data saved in the cache area, in which received data are stored, in the database as a record of the database and delete the data saved in the database from the cache area, based on the time period designated under the remaining condition.

6. The database management system according to claim 5, wherein the control unit is configured, when receiving an access request concerning the access target record from the application program and data corresponding to the access target record are present in the cache area, to instruct to the application program to access the data stored in the cache area, or acquire the data corresponding to the access target record from the cache area and provide the data to the application program.

7. The database management system according to claim 1, wherein
a plurality of records stored in the database correspond to a plurality of time series data,
the control unit is configured, in a case where the database does not have data satisfying a query condition designated in a query, to acquire data satisfying the query condition from a table based on a target file which is acquired from a file system storing one or more files corresponding to two or more time series data and contains data satisfying the query condition, and
the remaining condition includes one or more attributes out of a plurality of attributes concerning time series data and containing at least time points, and a value for each of the one or more attributes.

8. The database management system according to claim 7, wherein
the control unit is configured, based on placement management information and the remaining condition, to specify a record indicating a lapse of the predetermined time period since a time point corresponding to the record, and control on whether to delete or keep the specified record,
the placement management information is information for retaining, for each time series data group, a time point interval of a time series data group, a value for each of one or more attributes concerning the time series data group, and a placement location in which the time series data group is placed.

9. The database management system according to claim 8, wherein
the control unit is configured to:
divide the target file into a first file of one or more time series data containing data satisfying the query condition, and one or more second files of time series data other than the one or more time series data;
add, to the database, one or more records corresponding to the one or more time series data represented by the first file out of two or more time series data represented by the target file; and
register, in the placement management information, that a placement location of a time series data group represented as the first file is the database.

10. The database management system according to claim 8, wherein
time series data from one or more time series data sources are supposed to be accumulated in a cache area, and two or more records corresponding to two or more time series data accumulated in the cache area are stored in the database by a storage unit, and
the control unit is configured to:
receive, from the storage unit, the fact that a placement location for a time series data group, which is a set of two or more time series data that are accumulated in the cache area but stored neither in the database nor the file system, is the cache area; and
register, in the placement management information, that the placement location for this time series data group is the cache area.

11. The database management system according to claim 1, wherein the control unit is configured to keep a record that is accessed at a predetermined frequency or more, in the database even after a lapse of the predetermined time period since a time point corresponding to this record.

12. The database management system according to claim 1, wherein the reception unit is configured to receive the remaining condition through a user interface.

13. A computer for deleting, from a database storing information about time points associated with records, a record indicating a lapse of a predetermined time period since a time point indicated by associated information, the computer comprising:
an interface device coupled to a storage apparatus having the database; and
a processor coupled to the interface device,
the processor being configured to:
receive a remaining condition which indicates a time period during which a record is kept in the database regardless of the predetermined time period; and
control to keep a record in the database even after a lapse of the predetermined time period, based on the remaining condition.

14. A database management method for deleting, from a database storing information about time points associated with records, a record indicating a lapse of a predetermined time period since a time point indicated by corresponding information, the database management method comprising:
receiving a remaining condition which indicates a time period during which a record is kept in the database regardless of the predetermined time period; and
controlling to keep a record in the database even after a lapse of the predetermined time period, based on the remaining condition.
